(19) United States
(12) Patent Application Publication
(10) Pub. No.: US 2015/0286970 A1
(43) Pub. Date: Oct. 8, 2015

(54) SYSTEM AND PROCESS FOR RATING MAINTENANCE RISK ON HEALTHCARE AND GENERAL INDUSTRY EQUIPMENT

(71) Applicants: MICHAEL LLOYD DICKERSON, Carmel, IN (US); Nirjhareswar Banerjee, Kolkata, IN (US)

(72) Inventors: MICHAEL LLOYD DICKERSON, Carmel, IN (US); Nirjhareswar Banerjee, Kolkata, IN (US)

(21) Appl. No.: 14/247,841

(22) Filed: Apr. 8, 2014

(51) Int. Cl. G06Q 10/06; G06Q 50/22; G06Q 10/00

(52) U.S. Cl. CPC G06Q 10/0635; G06Q 10/20; G06Q 50/22

(57) ABSTRACT

Some embodiments of the invention include a novel system and process for rating maintenance risk on healthcare and general industry equipment. In some embodiments, the system includes a set of tools that provide accurate initial maintenance budgets and performance monitoring of actual service costs related to industry equipment. In some embodiments, the system uses the set of tools to automatically benchmark and rate maintenance risk on the devices and equipment in relation to associated service agreements. In some embodiments, the system uses the set of tools to analyze the devices and equipment related to the service agreements and monitor events associated with devices and equipment placed in service. In some embodiments, the set of tools of the system includes a maintenance risk calculation tool that calculates risk and automates performance of benchmarking and maintenance risk rating on the devices and equipment.

### BACKGROUND

Embodiments of the invention described in this specification relate generally to rating systems, and more particularly, to equipment and device maintenance risk rating systems and processes in the healthcare industry.

Computerized Maintenance Management systems from software providers do not focus on budgeting, only on tracking service expense. Service providers do not disclose granular information to protect their service relationships.

Therefore, what is needed is a way to provide accurate initial maintenance budgets and performance monitoring of actual service costs related to industry equipment and thereby allow self-insurance of maintenance risk in lieu of maintenance contracts and insurance programs by automating benchmarks that normally require significant research and analysis from other maintenance management systems.

### BRIEF DESCRIPTION

Some embodiments of the invention include a novel system and process for rating maintenance risk on healthcare and general industry equipment. In some embodiments, the system includes a set of tools that provide accurate initial maintenance budgets and performance monitoring of actual service costs related to industry equipment. In some embodiments, the system uses the set of tools to automatically benchmark and rate maintenance risk on the devices and equipment in relation to associated service agreements. In some embodiments, the system uses the set of tools to analyze the devices and equipment related to the service agreements and monitor events associated with devices and equipment placed in service. In some embodiments, the set of tools of the system includes a maintenance risk calculation tool that calculates risk and automates performance of benchmarking and maintenance risk rating on the devices and equipment.

In some embodiments, the maintenance risk calculation tool performs a process for benchmarking and rating maintenance risk on the devices and equipment. In some embodiments, the process identifies statistically significant trend data through data aggregation and measures performance across a plurality of device and equipment populations through dynamic rating and loss monitoring.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a schematic view of an equipment maintenance risk rating system in some embodiments.

FIG. 2 conceptually illustrates an example of a table structure used in an equipment maintenance risk rating system in some embodiments.

FIG. 3 conceptually illustrates a process for determining maintenance risk of devices in some embodiments.

FIGS. 4-7 conceptually illustrate a schematic view of a healthcare industry equipment maintenance risk rating system in some embodiments.

FIG. 8 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel system and process for rating maintenance risk on healthcare and general industry equipment. In some embodiments, the system includes a set of tools that provide accurate initial maintenance budgets and performance monitoring of actual service costs related to industry equipment. In some embodiments, the system uses the set of tools to automatically benchmark and rate maintenance risk on the devices and equipment in relation to associated service agreements. In some embodiments, the system uses the set of tools to analyze the devices and equipment related to the service agreements and monitor events associated with devices and equipment placed in service. In some embodiments, the set of tools of the system includes a maintenance risk calculation tool that calculates risk and automates performance of benchmarking and maintenance risk rating on the devices and equipment.

In some embodiments, the maintenance risk calculation tool performs a process for benchmarking and rating maintenance risk on the devices and equipment. In some embodiments, the process identifies statistically significant trend data through data aggregation and measures performance across a plurality of device and equipment populations through dynamic rating and loss monitoring.

Some embodiments of the system provide a web-based interface for users to perform operations for rating maintenance risk of one or more devices. Client users may be assigned specific access to tools/views that may differ among multiple users of an organization. In such embodiments, a software system includes calculation tools and one or more databases to rate maintenance risk on healthcare and general industry equipment. The system of some embodiments includes a plurality of common system types pre-rated for various service levels and conditions. In some embodiments, at least 40,000 common system types are included in the plurality of common system types. Actual service can be documented in the system and tracked against the established budget for the device. Statistically significant trend data thru data aggregation; rating and loss monitoring for dynamic performance measurement; numerous tools to measure performance across selected device populations automates benchmarks that normally require significant research and analysis from other maintenance management systems.

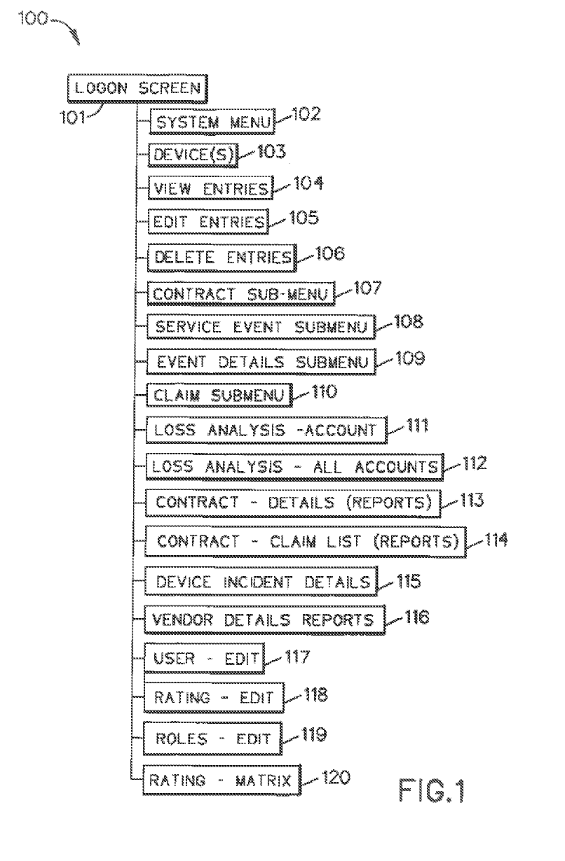

By way of example, FIG. 1 conceptually illustrates a schematic view of an example web-based equipment maintenance risk rating system 100 in some embodiments. As shown in this figure, the web-based equipment maintenance risk rating system 100 includes a logon screen 101 that allows a user of the system 100 to make selections through a system menu 102 to access devices 103, view entries 104, edit entries 105, delete entries 106, open a contract sub-menu 107, open a service event sub-menu 108, open an event details sub-menu 109, open a claim sub-menu 110, perform a loss analysis related to a particular account 111 (e.g., opening an account number input field for the user to enter the particular account number), perform loss analysis across all accounts 112, generate and review a contract detail report 113, generate and review a contract claim list report 114, review device incident details 115, generate and review reports of vendor details 116, edit user information 117, edit rating information 118, edit role information 119, and display a rating matrix 120.

The embodiments described in this specification differ from and improve upon currently existing options. In particular, some embodiments differ because the system allows client to rate their own maintenance budgets with assistance and see dynamic measurement of loss to budget for any device, any group, entire inventory. In addition, these embodiments improve upon the currently existing options because this is not provided by software companies and considered self-defeating by service providers that offer maintenance contracts.

There is no focus on financial performance (software companies), no data aggregation, no impetus to disclose information that lessens market need in other systems. In contrast, the system of some embodiments described in this specification performs data aggregation that allows statistically significant trend data to be ascertained. The system also performs rating and loss monitoring for dynamic performance measurement. In some embodiments, the system performs these and other operations by processes that are implemented in software system tools for measuring performance across selected device populations. The software tools thereby allow the system to automate benchmarks that normally require significant research and analysis from other maintenance management systems.

The system of the present disclosure may be comprised of the following elements. This list of possible constituent elements is intended to be exemplary only and it is not intended that this list be used to limit the system of the present application to just these elements. Persons having ordinary skill in the art relevant to the present disclosure may understand there to be equivalent elements that may be substituted within the present disclosure without changing the essential function or operation of the system.

1. Reference Data files—database tables for reference device identification and budget values.

2. Device Nomenclature—standard nomenclature for all devices and/or equipment.

3. Contracts Table—database tables for prospective and accepted contracts (for use by third-party service or program providers).

4. Service and Incident Tables—service and incident entry forms and tables.

5. Rating Matrix tools—rating matrix to forecast maintenance budget by labor, travel and parts usage.

6. Loss-to-Budget Comparison Tables—loss analysis database tables that track accrued service expense to adjusted annual budget by device or selected population.

7. Rating Tool—clinical risk rating tool for healthcare software application.

8. Service and Performance Tracking Tables—database tables for vendors utilized and ability to track extent of their service and performance.

9. File and Data Transmission Tools—uploading tools to import large inventory lists.

10. Reports—reports module (including tools for generating reports) that allows visibility of any device, group or entire account with respect to any of several metrics, computations, and/or views, including, without limitation, loss ratio, service events, labor hours, parts costs, etc.

11. Claims Tables—claims database tables allowing service events to be reviewed and approved (for use by third-party providers/insurers).

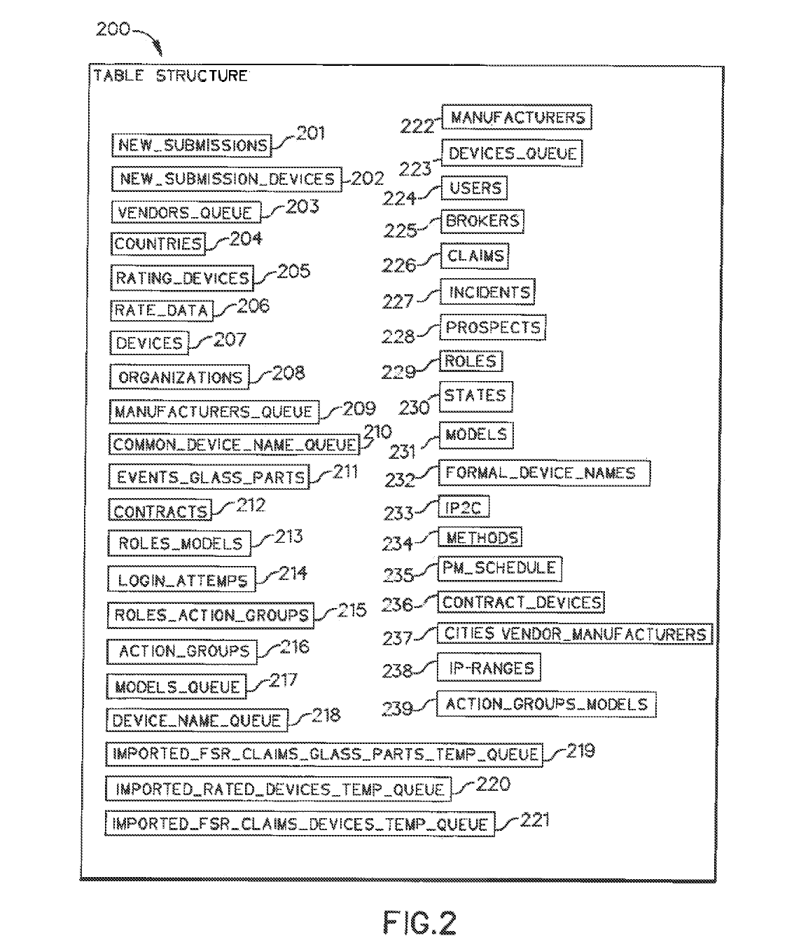

FIG. 2 conceptually illustrates an example of a table structure 200 used in the equipment maintenance risk rating system 100 in some embodiments. The table structure 200 includes several fields of information. The table structure 200 represents a logic structure of the information that the risk rating system 100 of some embodiments stores in a database. As shown in this figure, the table structure 200 includes fields with information for a new submission 201, new submission devices 202, a vendors queue 203, countries 204, rating devices 205, rate data 206, devices 207, organizations 208, a manufacturers queue 209, a common device name queue 210, events glass parts 211, contracts 212, roles models 213, login attempts 214, roles action groups 215, action groups 216, models queue 217, formal device name queue 218, imported FSR claims glass parts temporary queue 219, imported rated devices temporary queue 220, imported FSR claims devices temporary queue 221, manufacturers 222, devices queue 223, users 224, brokers 225, claims 226, incidents 227, prospects 228, roles 229, states 230, models 231, formal device names 232, IP to country (i.e., IP2C) 233, methods 234, PM schedule 235, contract devices 236, cities vendor manufacturers 237, IP ranges 238, and action groups models 239.

The various elements of the system of the present disclosure as presented in the figures and in this Specification may be related in the following exemplary fashion. It is not intended to limit the scope or nature of the relationships between the various elements and the following examples are presented as illustrative examples only. Reference Data files (1) and Claims Tables (11) are used with Rating Matrix tools (5) to calculate annual maintenance budgets for devices. The average values supplied by rating iterations and actual losses (claims) form guideposts for the user who can use average values (labor, travel, parts) or enter others if conditions require it. Service and Incidents tables (4) provide the service data claims 11) and log untoward device events for historical reference and compliance (primarily a healthcare concern). Incidents feed Clinical Risk rating (7) assignments which drive device inspection frequencies and protocols. Reports (10) summarize all financial metrics for each device and all selected device groupings.

The system of the present disclosure generally works by tools and other functions are intuitive and menu-driven. From a functional standpoint, the rating matrix guides less experienced users by providing average rating and loss values from matching or similar devices. Measurement of actual results to “rated” budget demonstrate performance variances clearly, allowing adjustments to rating protocol driven by device use, change in cost, vendor responsible, etc. Maintenance databases, especially in the healthcare space are used routinely but none emphasize the financial aspect of maintenance management. This leads to snap decisions to sign maintenance contracts or asset management programs since the financial risk is not understood well enough to fund from operations.

In some web-based embodiments of the system, a process is performed when a user of the system accesses tools for benchmarking and rating maintenance risk of one or more devices. For example, a user of the web-based system 100 described by reference to FIG. 1 would begin by logging into the system 100. If the user is an organization-approved client (i.e., the user credentials at logon can be authenticated by the system), then the client will be able to use one or more of the available tools of the system 100 to perform risk maintenance rating and/or benchmarking operations with respect to one or more devices. In some embodiments, the system 100 may assign a specific (and limited) set of access permissions that grant the client access to certain assigned tools and/or views which may differ for different users (clients) of an organization.

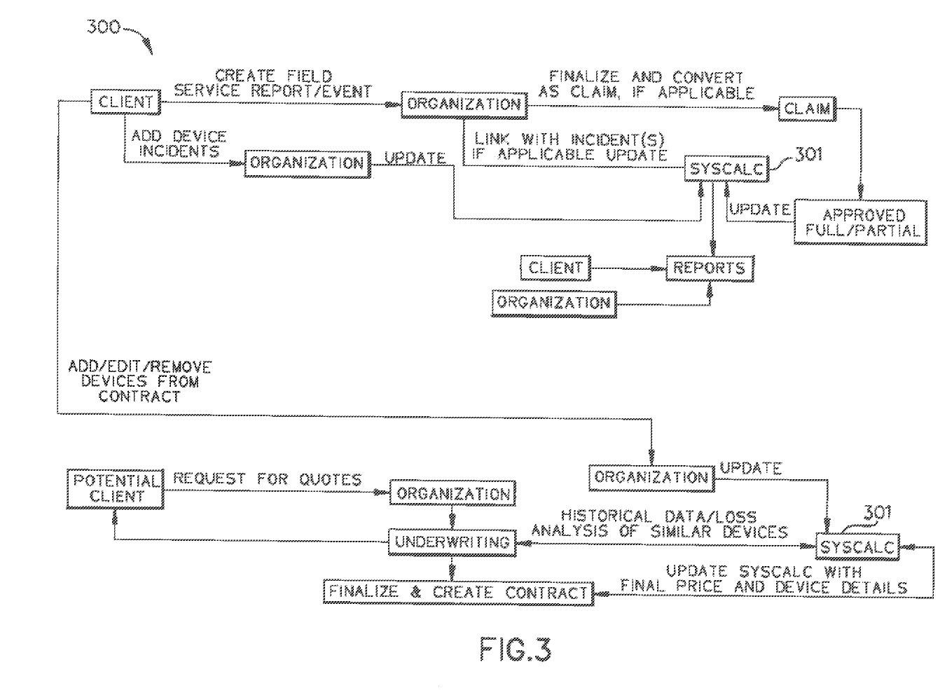

FIG. 3 conceptually illustrates a process for determining maintenance risk of devices in some embodiments. As shown in this figure, the client can start by creating a field service report/event or by adding device incidents to the system. As the client may be an internal organization user or a third party user (i.e., a user who is external to the organization), the client's selection to start an action (i.e., create report or event, update, or add incident) will be transmitted to the organization so that the process 300 can perform the next operation (i.e., convert to a claim, link with incident, and/or update). A new claim is first transmitted to an operation that awaits an approval, either in full or in part. The process then uses the calculation tool to determine the maintenance risk associated with the device. For instance, if a new claim was created for a new incident, the calculation determines risk based on existing data as described above, while an update to an incident will cause the process to recalculate the maintenance risk in light of the updated data. After the risk calculation is performed, the process generates a report. In some embodiments, the client or the organization starts by requesting a report, which the process delivers based on existing data.

Similarly, a potential client in some embodiments can request a quote to start the process. The request is routed to the organization which directs the request to underwriting. As the process performs actions of the system, which is a computer system with elements that are generally available, the process of some embodiments includes sub-processes directed at collecting and normalizing data. The overall design of some embodiments includes aspects related to both the equipment and devices that are considered in the processes and aspects of underwriting which inform the reference rating data tables and tools, service/claims data tables and tools, loss analysis calculation tools and tabular results; and in some cases, clinical risk rating, and incident entry forms and tables. In this way, the process can finalize and create a contract after the calculated risk based on the request received from the potential client.

As mentioned above, the tools that implement the process 300 can be tools used by “equipment owner” organizations as well as third-party service and program providers, and are similar regardless of industry. In some cases, baseline reference information may need to be expanded for typical equipment populations for the industry.

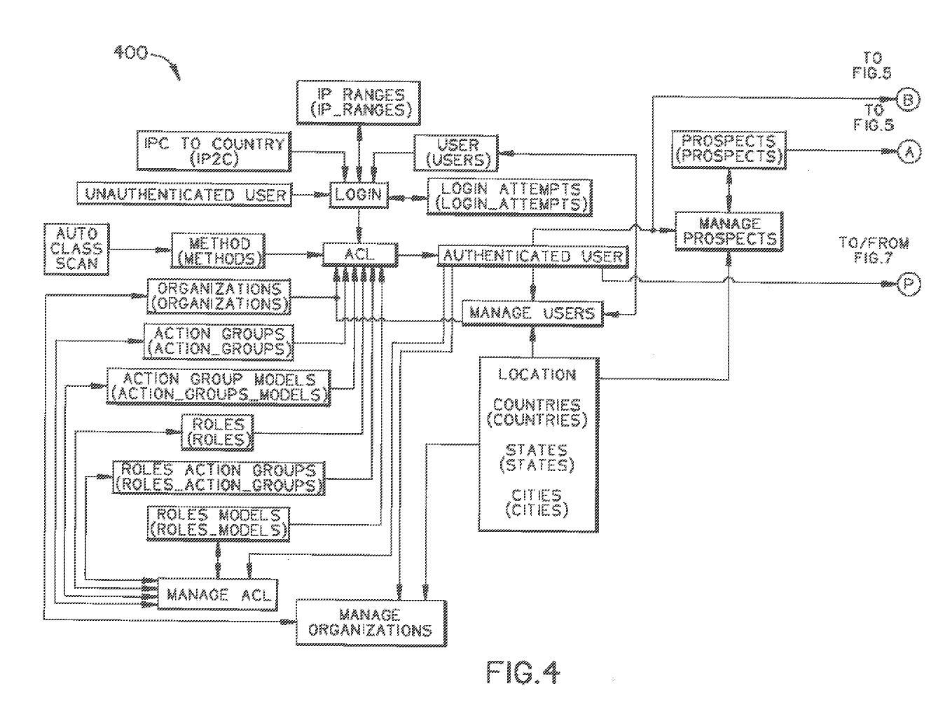

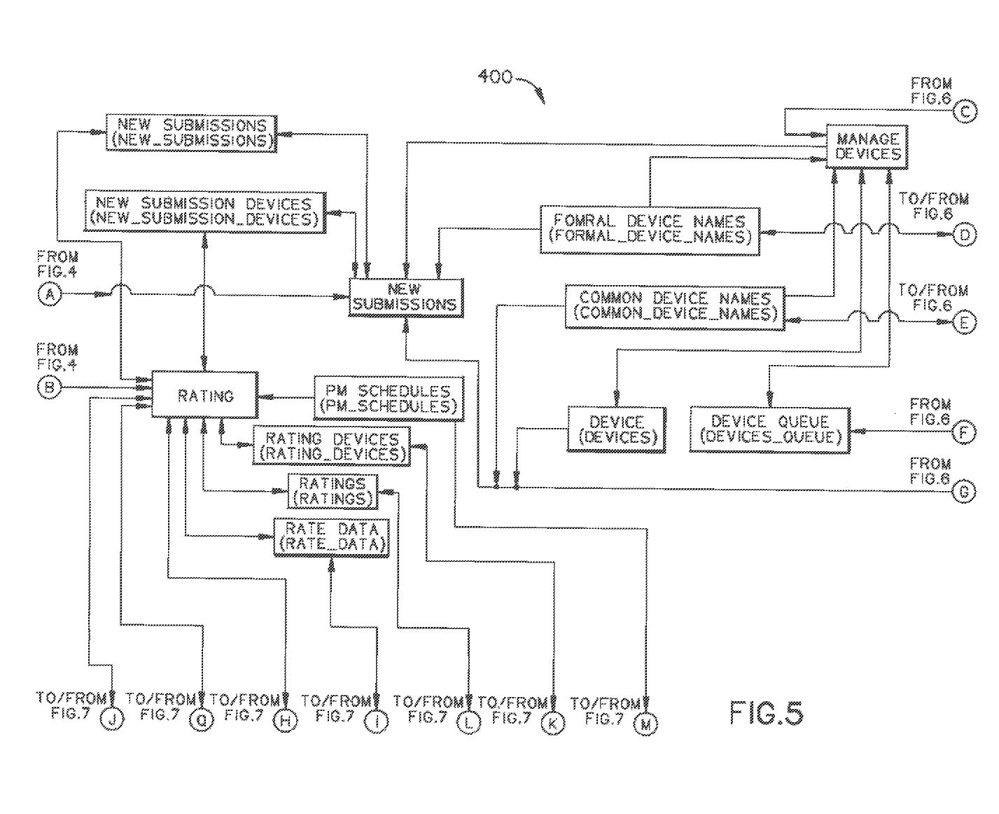

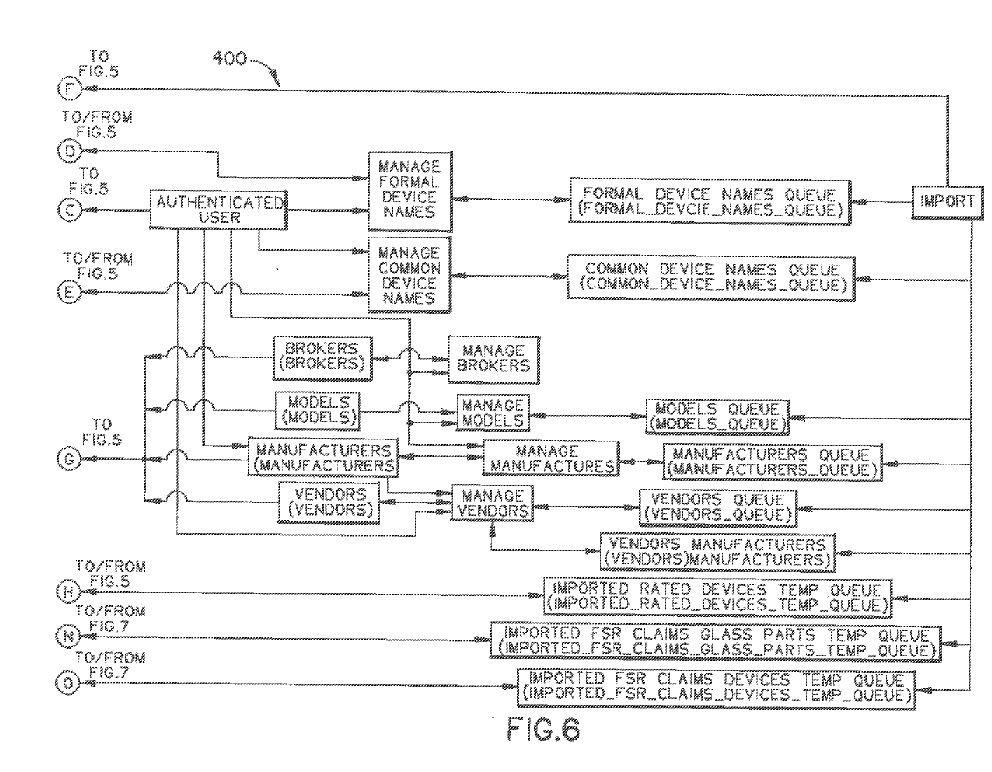

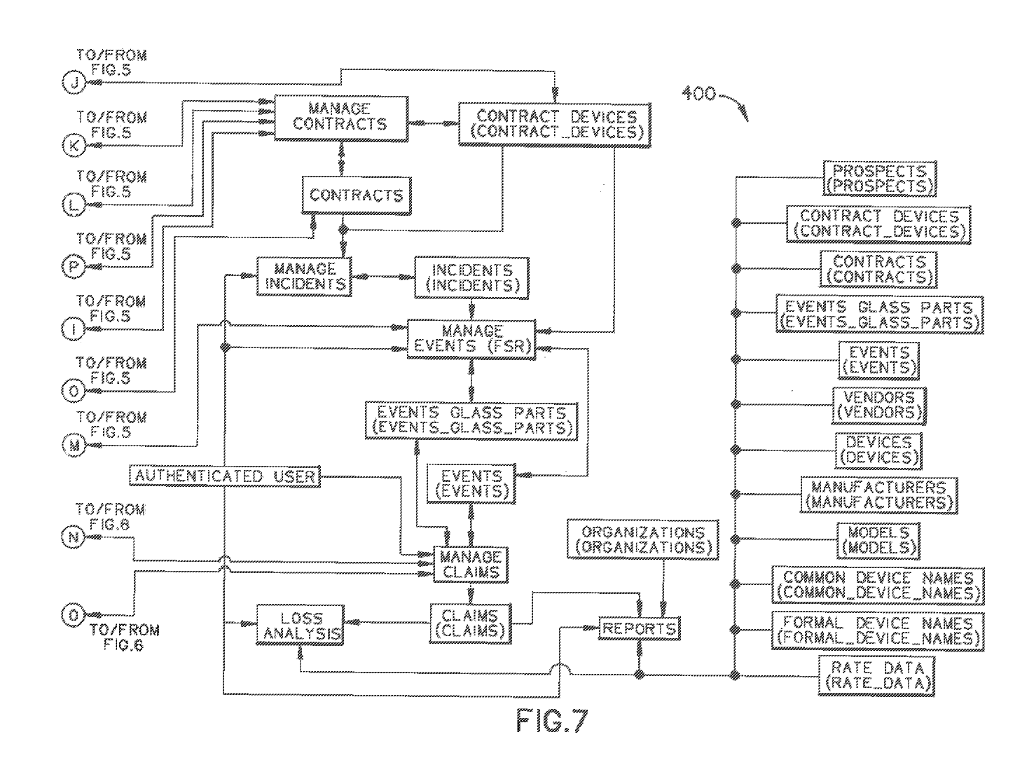

FIGS. 4-7 conceptually illustrate a schematic view of a healthcare industry equipment maintenance risk rating system in some embodiments. As shown in this figure, the system includes data operations that coincide with the fields of the table structure 200 described above by reference to FIG. 2. This detailed flow exemplifies the many different possibilities the system covers when a risk calculation is to be performed.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention.

Also, many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

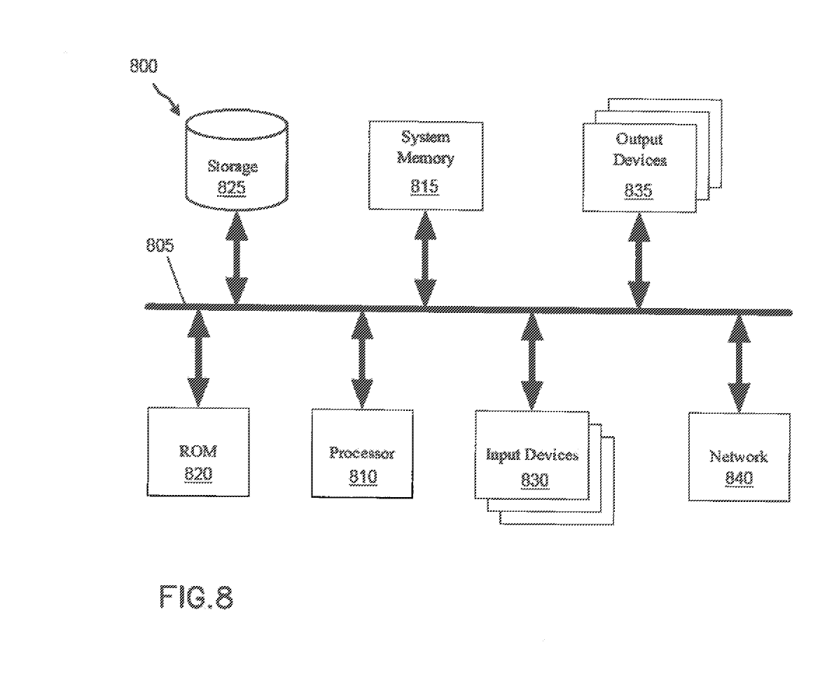

FIG. 8 conceptually illustrates an electronic system 800 with which some embodiments of the invention are implemented. The electronic system 800 may be a computer, phone, PDA, or any other sort of electronic device. Such an electronic system includes various types of computer readable media and interfaces for various other types of computer readable media. Electronic system 800 includes a bus 805, processing unit(s) 810, a system memory 815, a read-only 820, a permanent storage device 825, input devices 830, output devices 835, and a network 840.

The bus 805 collectively represents all system, peripheral, and chipset buses that communicatively connect the numerous internal devices of the electronic system 800. For instance, the bus 805 communicatively connects the processing unit(s) 810 with the read-only 820, the system memory 815, and the permanent storage device 825.

From these various memory units, the processing unit(s) 810 retrieves instructions to execute and data to process in order to execute the processes of the invention. The processing unit(s) may be a single processor or a multi-core processor in different embodiments.

The read-only-memory (ROM) 820 stores static data and instructions that are needed by the processing unit(s) 810 and other modules of the electronic system. The permanent storage device 825, on the other hand, is a read-and-write memory device. This device is a non-volatile memory unit that stores instructions and data even when the electronic system 800 is off. Some embodiments of the invention use a mass-storage device (such as a magnetic or optical disk and its corresponding disk drive) as the permanent storage device 825.

Other embodiments use a removable storage device (such as a floppy disk or a flash drive) as the permanent storage device 825. Like the permanent storage device 825, the system memory 815 is a read-and-write memory device. However, unlike storage device 825, the system memory 815 is a volatile read-and-write memory, such as a random access memory. The system memory 815 stores some of the instructions and data that the processor needs at runtime. In some embodiments, the invention's processes are stored in the system memory 815, the permanent storage device 825, and/or the read-only 820. For example, the various memory units include instructions for processing appearance alterations of displayable characters in accordance with some embodiments. From these various memory units, the processing unit(s) 810 retrieves instructions to execute and data to process in order to execute the processes of some embodiments.

The bus 805 also connects to the input and output devices 830 and 835. The input devices enable the user to communicate information and select commands to the electronic system. The input devices 830 include alphanumeric keyboards and pointing devices (also called “cursor control devices”). The output devices 835 display images generated by the electronic system 800. The output devices 835 include printers and display devices, such as cathode ray tubes (CRT) or liquid crystal displays (LCD). Some embodiments include devices such as a touchscreen that functions as both input and output devices.

Finally, as shown in FIG. 8, bus 805 also couples electronic system 800 to a network 840 through a network adapter (not shown). In this manner, the computer can be a part of a network of computers (such as a local area network (“LAN”), a wide area network (“WAN”), or an intranet), or a network of networks (such as the Internet). Any or all components of electronic system 800 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For instance, FIGS. 3 and 4-7 conceptually illustrate processes. The specific operations of these processes may not be performed in the exact order shown and described. Specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

I claim:

1. A non-transitory computer readable medium storing a program which when executed by at least one processing unit of a computing device provides accurate initial maintenance budgets and performance monitoring of actual service costs related to devices of an organization, said program comprising sets of instructions for:
receiving a client selection of an action to perform in relation to a particular device;
calculating maintenance risk associated with the particular device; and
generating a report comprising the calculated rating maintenance risk for the particular device.

2. The non-transitory computer readable medium of claim 1, wherein the client is one of an internal organization user, an external third party user, and a potential customer.

3. The non-transitory computer readable medium of claim 1, wherein the program further comprises a set of instructions for routing the received client selection to the organization to determine the type of action to perform in relation to the particular device.

4. The non-transitory computer readable medium of claim 3, wherein the program further comprises a set of instructions for receiving the type of action determined by the organization, said type of action comprising one of creating a new incident associated with the particular device, updating an existing incident associated with the particular device, and generating a report associated with the particular device.

5. The non-transitory computer readable medium of claim 1, wherein the set of instructions for calculating the maintenance risk comprises sets of instructions for:
aggregating data associated with the particular device; and
normalizing the aggregated data based on a set of comparison data of a set of devices that each satisfy a threshold level of similarity with the particular device.

6. The non-transitory computer readable medium of claim 1, wherein the program further comprises a set of instructions for waiting to calculate maintenance risk associated with the particular device until a new claim action is approved.

7. An equipment and device maintenance risk system that determines maintenance risk for a set of devices of an organization, said system comprising:
a web server computing device comprising a processor, a memory unit, and a network interface card that connects the web server computing device to a network accessible by clients of the organization;
a web server software application that runs on the processor of the web server computing device, said web server software application comprising a user interface with a plurality of operations for clients of the organization to select in relation to one or more devices;
a set of databases comprising a set of database tables that organize and store data associated with the set of devices of the organization; and
a risk maintenance rating tool that (i) operates in connection with an operation to perform for a particular device, (ii) retrieves data associated with the particular device from at least one database in the set of databases, and (iii) calculates risk maintenance for the particular device.

8. The equipment and device maintenance risk system of claim 7 further comprising a reporting tool that generates reports for clients in relation to one or more devices.

9. The equipment and device maintenance risk system of claim 7 further comprising an automated maintenance risk trend analyzer tool that automatically performs data aggregation, rating and loss monitoring, and dynamic performance measurements for the system.

10. The equipment and device maintenance risk system of claim 7 further comprising a rating matrix to forecast maintenance budgets by labor, travel, and parts usage.
